(19) United States
(12) Patent Application Publication
(10) Pub. No.: US 2023/0383937 A1
(43) Pub. Date: Nov. 30, 2023

(54) LIGHTING SYSTEM COMPRISING LIGHT SOURCE DRIVER SEPARATED FROM LIGHT SOURCE UNIT AND METHOD THEREOF FOR ILLUMINATING BUILDINGS

(71) Applicant: Tactik Lighting LLC, Sheboygan, WI (US)

(72) Inventors: Tim Wasmer, Kiel, WI (US); Dave Wasmer, New Holstein, WI (US); Jun Wang, Sheboygan, WI (US)

(73) Assignee: Tactik Lighting LLC, Sheboygan, WI (US)

(21) Appl. No.: 18/366,654

(22) Filed: Aug. 7, 2023

Related U.S. Application Data
(63) Continuation of application No. 18/151,451, filed on Jan. 8, 2023.
Application No. 18/151,451 is a continuation-in-part of application No. 17/445,495, filed on Aug. 19, 2021, now abandoned.
(60) Provisional application No. 63/067,876, filed on Aug. 20, 2020.

(51) Int. Cl. F21V 23/00; F21S 4/28

(52) U.S. Cl. CPC F21V 23/008; F21S 4/28; F21Y 2115/10

(57) ABSTRACT

The present invention provides a lighting system comprising a main power source, a light source driver electrically coupled to the main power source, and a light source unit driven by the light source driver. The light source driver is encased within a dedicated or independent driver housing. The light source driver and the driver housing are physically and electrically connected to the light source unit via a flexible cord. The length of the flexible cord is so configured that the light source unit can be installed at different locations inside a building without moving the light source driver around.

### FIELD OF THE INVENTION

The present invention generally relates to a lighting or illumination system comprising a light source driver separated from the light source unit and method thereof for illuminating buildings. Although the invention will be illustrated, explained and exemplified by a LED board that can be moveable relative to a stationary LED driver, it should be appreciated that the present invention can also be applied to any other suitable light source, for example solid-state lighting (SSL) fixtures that comprises organic light-emitting diodes (OLED) or polymer light-emitting diodes (PLED), e.g. a (retrofit) lamp, and the like.

### BACKGROUND OF THE INVENTION

LEDs are solid state light emitting devices formed of semiconductors, and LED lighting is superior to lighting using an incandescent lamp, fluorescent lamp etc. in terms of lower power consumption, lower heat generation, longer life, better stability, higher reliability and higher response speed. As such, LEDs are widely used in various fields such as light sources for lighting, alphanumeric display elements, signal lights, and display devices.

However, the LEDs are very weak against heat. When temperature is higher than an allowable temperature, the LED is reduced in light emitting efficiency and has its life affected. In order to solve these problems, the heat generated when the LED element emits light needs to be dissipated into a space surrounding the LED element and hence the LED lighting is provided with a large heat sink. Typically, a LED lighting apparatus is provided with a heat sink disposed to adjoin a heat sink base or a printed circuit board (PCB), on which LEDs are mounted, to dissipate heat. However, it is recognized that such a lighting apparatus suffers from many restrictions in improvement of heat dissipation efficiency through the heat sink.

Moreover, in some LED lighting apparatuses, a power supply such as a switching mode power supply (SMPS) is received within a housing. When AC current is supplied from outside, the SMPS converts the AC current into DC current and supplies the DC current to the LEDS in the housing. However, since the power supply such as SMPS generates large amounts of heat during operation and the heat remains at an upper housing section.

In the prior art, the LED driver is the weakest link, and everyone has the driver mounted in the fixture. If the LED driver fails, one has to either throw the fixture away, or pull it apart and repair it. Another problem is that a user has to regrid the electrical if the user wants to move the fixtures around. National Electrical Code requires that building voltage to be within the footprint of the LED fixture. If the user wants to move a fixture, he/she has to relocate the building electrical where the fixture's new location will be.

Therefore, there exists a need to overcome the aforementioned problems. Advantageously, the present invention provides a lighting or illumination system comprising a light source driver separated from the light source unit and method thereof for illuminating buildings, that can solve these problems.

### SUMMARY OF THE INVENTION

One aspect of the present invention provides a lighting system comprising a main power source, a light source driver electrically coupled to the main power source, and a light source unit driven by the light source driver. The light source driver is encased within a dedicated or independent driver housing. The light source driver and the driver housing are physically and electrically connected to the light source unit via a flexible cord. The length of the flexible cord is so configured that the light source unit can be installed at different locations inside a building without moving the light source driver around.

Another aspect of the invention provides a method of illuminating the internal space of a building, comprising:
(i) providing a lighting system as described above;
(ii) mounting the light source driver in a first location in the building;
(iii) mounting the light source unit in a second location in the building; and
(iv) moving the light source unit to, and mounting it in, a third location in the building without moving the light source driver away from the first location and without re-griding the utility electrical system in the building.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements. All the figures are schematic and generally only show parts which are necessary in order to elucidate the invention. For simplicity and clarity of illustration, elements shown in the figures and discussed below have not necessarily been drawn to scale. Well-known structures and devices are shown in simplified form, omitted, or merely suggested, in order to avoid unnecessarily obscuring the present invention.

FIG. 1 schematically illustrates a lighting system in accordance with an exemplary embodiment of the present invention.

FIG. 2 schematically illustrates a light source driver and its housing physically and electrically connected to the light source unit via a flexible cord in accordance with an exemplary embodiment of the present invention.

FIG. 3 is a flow chart showing a method of illuminating the internal space of a building in accordance with an exemplary embodiment of the present invention.

FIG. 4 is a flow chart showing a method of providing a lighting system in accordance with an exemplary embodiment of the present invention.

FIG. 5 is cross-sectional view of a light source driver and its driver housing in accordance with an exemplary embodiment of the present invention.

FIG. 6 shows a light source driver and its housing in accordance with an exemplary embodiment of the present invention.

FIG. 7 shows two or more light source drivers in a single shared housing in accordance with an exemplary embodiment of the present invention.

FIG. 8 demonstrates the external structure of a light source driver housing in accordance with an exemplary embodiment of the present invention.

FIG. 9 demonstrates the structure of two light source units in accordance with an exemplary embodiment of the present invention.

FIG. 10 shows expandable light fixtures in accordance with an exemplary embodiment of the present invention.

FIG. 11 schematically shows zig-zag LED boards for a light fixture in accordance with an exemplary embodiment of the present invention.

FIG. 12 depicts internal cooling fins in a LED fixture in accordance with an exemplary embodiment of the present invention.

FIG. 13 shows the wiring assembly of a remote light source driver in its housing in accordance with an exemplary embodiment of the present invention.

FIG. 14 schematically illustrates a lighting system in accordance with an exemplary embodiment of the present invention.

Inventors Tim Wasmer, Dave Wasmer and Jun Wang have also invented a new, original, and ornamental design for a LED Driver Housing, and claim the ornamental design for a LED Driver Housing, as shown and described in the following and in FIGS. 15-27.

FIG. 15 is a front/right/bottom perspective view of a first embodiment of a LED Driver Housing;

FIG. 16 is a front/right/top perspective view thereof;

FIG. 17 is a rear/right/bottom perspective view thereof; and

FIG. 18 is a right-side elevational view thereof.

FIG. 19 is a front/left/bottom perspective view of a second embodiment of a LED Driver Housing.

FIG. 20 is a front/right/bottom perspective view of a third embodiment of a LED Driver Housing;

FIG. 21 is a front/right/top perspective view thereof;

FIG. 22 is a rear/right/bottom perspective view thereof; and

FIG. 23 is a right-side elevational view thereof.

FIG. 24 is a front/left/bottom perspective view of a fourth embodiment of a LED Driver Housing.

FIG. 25 is a rear/left/top perspective view of a fifth embodiment of a LED Driver Housing;

FIG. 26 is a front/left/bottom perspective view thereof and

FIG. 27 is rear/left/bottom perspective view thereof.

Inventors Tim Wasmer, Dave Wasmer and Jun Wang have also invented a new, original, and ornamental design for a Lighting Fixture such as a LED Lighting Fixture, and claim the ornamental design for a Lighting Fixture such as a LED Lighting Fixture, as shown and described in the following and in FIGS. 28-48.

FIG. 28 is a front/left/bottom perspective view of a first embodiment of a Lighting Fixture (Citadel);

FIG. 29 is a rear/left/top perspective view thereof;

FIG. 30 is a rear/left/bottom perspective view thereof;

FIG. 31 is a rear/right/bottom perspective view thereof; and

FIG. 32 is a left side elevational view thereof.

FIG. 33 is a front/left/bottom perspective view of a second embodiment of a Lighting Fixture (Citadel);

FIG. 34 is a rear/left/top perspective view thereof; and

FIG. 35 is a left side elevational view thereof.

FIG. 36 is a front/left/bottom perspective view of a third embodiment of a Lighting Fixture (Citadel);

FIG. 37 is a rear/left/top perspective view thereof; and

FIG. 38 is a left side elevational view thereof.

FIG. 39 is a front/left/bottom perspective view of a fourth embodiment of a Lighting Fixture (NCO).

FIG. 40 is a front/left/top perspective view of a fifth embodiment of a Lighting Fixture (NCO); and

FIG. 41 is a rear/left/top perspective view thereof.

FIG. 42 is a rear/left/top perspective view of a sixth embodiment of a Lighting Fixture (NCO); and

FIG. 43 is a left side elevational view thereof.

FIG. 44 is a rear/left/top perspective view of a seventh embodiment of a Lighting Fixture (NCO); and

FIG. 45 is a left side elevational view thereof.

FIG. 46 is a front/left/bottom perspective view of an eighth embodiment of a Lighting Fixture (NCO).

FIG. 47 is a front/left/bottom perspective view of a ninth embodiment of a Lighting Fixture (NCO).

FIG. 48 is a front/left/bottom perspective view of a tenth embodiment of a Lighting Fixture (NCO).

Inventors Tim Wasmer, Dave Wasmer and Jun Wang have also invented a new, original, and ornamental design for a LED Board used in any LED lighting Fixture, and claim the ornamental design for a LED Board used in any LED lighting Fixture, as shown and described in the following and in FIGS. 49-54.

FIG. 49 is a bottom plan view of a first embodiment of a LED Board;

FIG. 50 is a bottom plan view of a second embodiment of a LED Board;

FIG. 51 is a bottom plan view of a third embodiment of a LED Board;

FIG. 52 is a bottom plan view of a fourth embodiment of a LED Board;

FIG. 53 is a bottom plan view of a fifth embodiment of a LED Board; and

FIG. 54 is a bottom plan view of a sixth embodiment of a LED Board.

Inventors Tim Wasmer, Dave Wasmer and Jun Wang have also invented a new, original, and ornamental design for a LED Lighting System (or Product, or Assembly), and claim the ornamental design for a LED Lighting System (or Product, or Assembly), as shown and described in the following and in FIGS. 55-58.

FIG. 55 is a front elevational view of a first embodiment of the LED Lighting System (or Product, or Assembly);

FIG. 56 is a front elevational view of a second embodiment of the LED Lighting System (or Product, or Assembly);

FIG. 57 is a front elevational view of a third embodiment of the LED Lighting System (or Product, or Assembly); and

FIG. 58 is a front elevational view of a fourth embodiment of the LED Lighting System (or Product, or Assembly).

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement.

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

It is also to be understood that the terminology used herein is for the purpose of describing particular embodiments only, and is not intended to limit the scope of the invention. For example, when an element is referred to as being “on”, “connected to”, or “coupled to” another element, it can be directly on, connected or coupled to the other element or intervening elements may be present. In contrast, when an element is referred to as being “directly on”, “directly connected to”, or “directly coupled to” another element, there are no intervening elements present.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

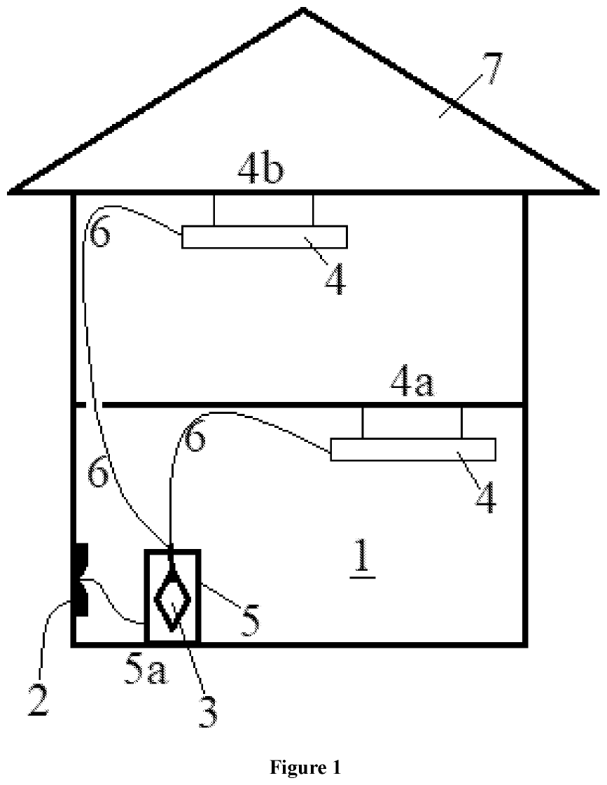

With reference to FIG. 1, a lighting system 1 is installed in a building 7. Examples of the building 7 include, but are not limited to, residential buildings, commercial buildings, retail buildings, shopping centers, motels, hotels, casinos, resorts, self-storages, warehouses, car washes, theaters, office buildings, laboratories, data centers, call centers, showrooms, industrial buildings, agricultural buildings, barns, chicken coops or chicken houses, cow-sheds, farmhouses, greenhouse, institutional buildings, arenas, libraries, museums, observatories, community halls, churches, cathedrals, temples, city halls, courthouses, police stations, post offices, airport terminal, bus station, subway stations, railroad stations, film studios, gyms, and the like.

The lighting system 1 includes a main power source 2 such as an electrical socket connected to a power grid, a public utility electrical grid, or a DC power source. A light source driver 3 is electrically coupled to the main power source 2. The driver 3 is encased within, housed in a dedicated or independent driver housing 5 at a location 5a of the building 7.

A light source unit 4 is driven by the light source driver 3. Examples of the light source units include, but are not limited to, solid-state lighting (SSL) fixtures such as a semiconductor light-emitting diode (LED), organic light-emitting diodes (OLED), polymer light-emitting diodes (PLED), or any combination thereof, e.g. a (retrofit) lamp.

As shown in FIG. 1, the light source driver 3 and the driver housing 5 are physically and electrically connected to the light source unit 4 via a flexible cord 6. The length of the flexible cord 6 is so configured that the light source unit 4 can be installed at different locations (4a, 4b . . . ) inside the building 7 without moving the light source driver 3 around, i.e. keeping the driver 3 stationary. As shown in FIG. 1, the light source units 4 and the driver 3 are not mechanically fixed in a same case, housing, box, container, bracket, frame, or package. The light source units 4 is not mechanically fixed or mounted to the driver housing 5 either. The light source driver 3 is not mechanically fixed or mounted to the light source units 4. As such, when the light source unit 4 is in a working condition such as illuminating light, the light source driver 3 is movable relatively to the light source unit 4.

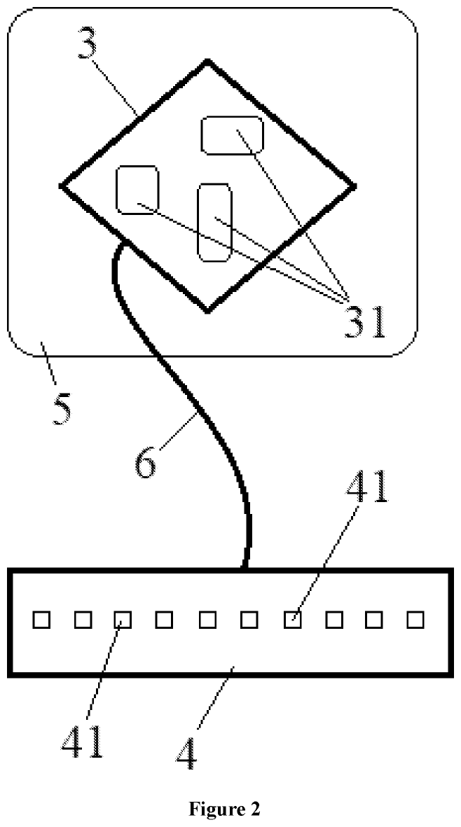

In exemplary embodiments as shown in FIG. 2, the light source driver 3 may be an isolated power driver, such as a LED driver with a LED circuit to power a light-emitting diode 41 (LED) in the light source unit 4. The light source unit 4 may include one or more light-emitting diodes 41 of a LED circuit. For example, the light source unit 4 may include a string or an array of multiple LEDs 41 that are connected in series. In order to obtain a higher illumination, a plurality of LED elements 41 may be placed on a base board (a substrate for LED mounting) formed of a metal such as aluminum and to dispose, around the LED elements, reflectors for reflecting light in a predetermined direction. In some embodiments, the multiple LEDs 41 are mounted on a LED board having two or more boundaries/edges with a zig zag (shark's teeth) profile. It should be appreciated that any suitable light source unit 4 can be used in the invention, for example, a desk lamp bulb; a vanity bulb; a tube bulb; a flood light bulb; a candle bulb; an omnidirectional bulb; a globe shaped bulb; a cylindrical tub shaped bulb; a globe shaped cover bulb; an omnidirectional bulb comprising at least one concavity; and the like.

All other (non-LED) components 31 of the LED circuit may be included in the light source driver 3 within the driver housing 5. These non-LED components 31 of the LED circuit may be used to control or regulate the current level of a LED current through the LED 41 and thus control or regulate the light output of the LED 41. Examples of non-LED components 31 of the LED circuit include, but are not limited to, a current-limiting resistor such as a series resistor, an active constant current regulator, a depletion-mode MOSFET (metal-oxide-semiconductor field-effect transistor), a low drop-out (LDO) constant current regulator, a switched-mode power supply, a power MOSFET, a power integrated circuit (IC) chip, a power switch, an electromagnetic relay including a coil, a rectifier, a pulse-width modulator, an AC/DC converter or inverter configured to transform alternating current (AC) power to direct current (DC) power, and the like. For example, the main power source 2 may be e.g. a commercial power source, and its AC voltage may be e.g. 100 V. The power driver 3 may be able to convert 100-300 V such as 100 V or 277 VAC current to 10-18 V DC current.

In some embodiments, the LED circuit ensures the correct polarity, because LEDs will only light with correct electrical polarity. When the voltage across the p-n junction is in the correct direction, a significant current flows and the device is forward-biased. If the voltage is of the wrong polarity, the device is reverse biased, very little current flows, and no light is emitted. In some embodiments, the LED circuit ensures that LEDs are operated on an alternating current voltage, but they will only light with positive voltage, causing the LED to turn on and off at the frequency of the AC supply. In some embodiments, the LED circuit pulses LEDs on and off, by applying power periodically or intermittently. As long as the flicker rate is greater than the human flicker fusion threshold and the LED is stationary relative to the eye, the LED will appear to be continuously lit. Varying the on/off ratio of the pulses is known as pulse-width modulation. In some embodiments, PWM-based drivers are more efficient than constant current or constant voltage drivers. The LED light output is generally controlled by regulating a current level of a LED current through the LED. The LED current may be further modulated with, e.g. a pulse width modulation (PWM) scheme. In such a PWM-scheme, the LED receives the LED current in a periodic sequences of pulses of a certain width, while the width of the pulses is modulated from a first pulse width to a second pulse width when the effective light output is to be changed from a first light output level to a second light output level.

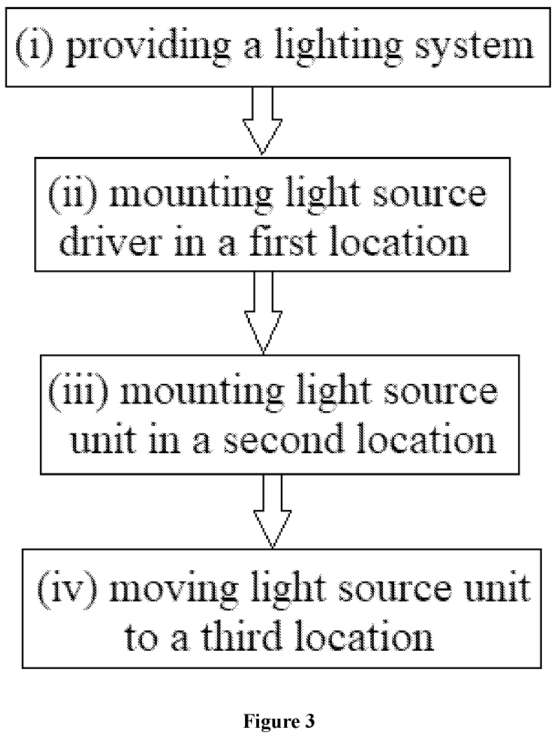

The present invention also provides a method of illuminating the internal space of a building 7. As shown in FIG. 3, the method includes the following steps: (i) providing a lighting system 1 as described above and as illustrated in FIGS. 1 and 2; (ii) mounting the light source driver 3 in a first location 5a in the building 7; (iii) mounting the light source unit 4 in a second location 4a in the building 7; (iv) moving the light source unit 4 to, and mounting it in, a third location 4b in the building 7 without moving the light source driver 3 away from the first location 5a, without re-griding the utility electrical system in the building 7.

An advantage of the invention is that, when the light source driver 3 fails, the user can keep (not throw away) the light source unit 4 or the user can maintain the integrity of the light source unit 4 without pulling it apart and repairing it. By the same token, when the light source unit 4 fails, the user can keep (not throw away) the light source driver 3 or the user can maintain the integrity of the light source driver 3 without pulling it apart and repairing it.

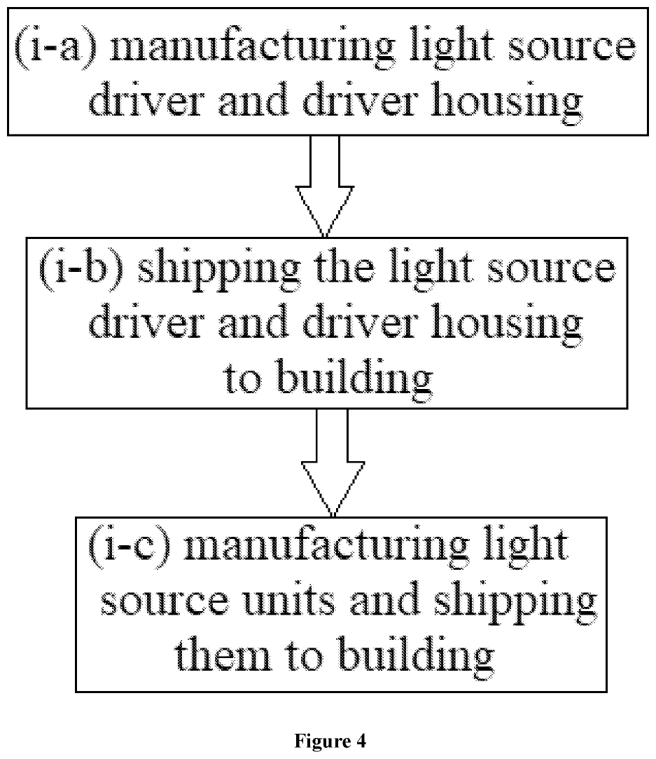

In preferred embodiments, the first location 5a has a temperature lower than the second location 4a or the third location 4b. Additionally, as shown in FIG. 4, step (i) of the method may include specific steps of (i-a) manufacturing the light source driver 3 and/or its driver housing 5 before manufacturing the light source unit 4, (i-b) shipping the light source driver 3 and/or its driver housing 5 to the building 7 as needed, and (i-c) manufacturing one or more light source units 4 and shipping the units 4 to the building 7 as needed after step (i-b).

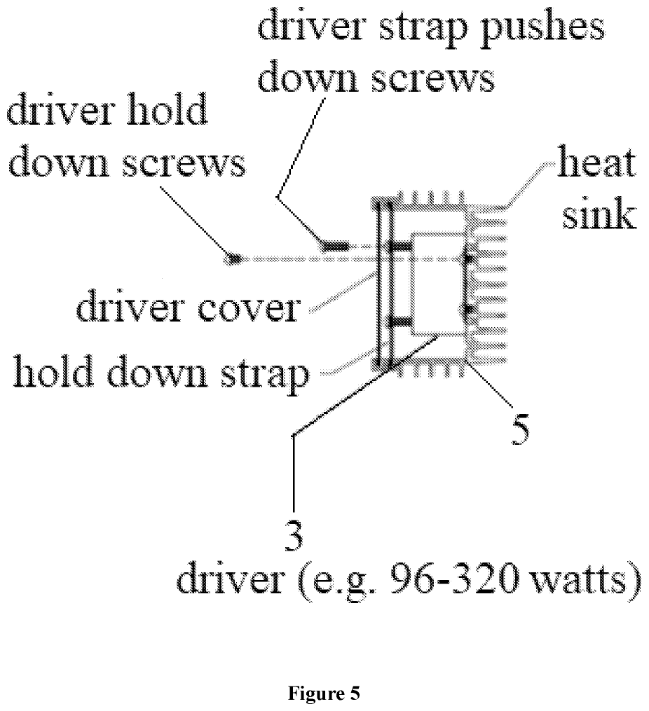

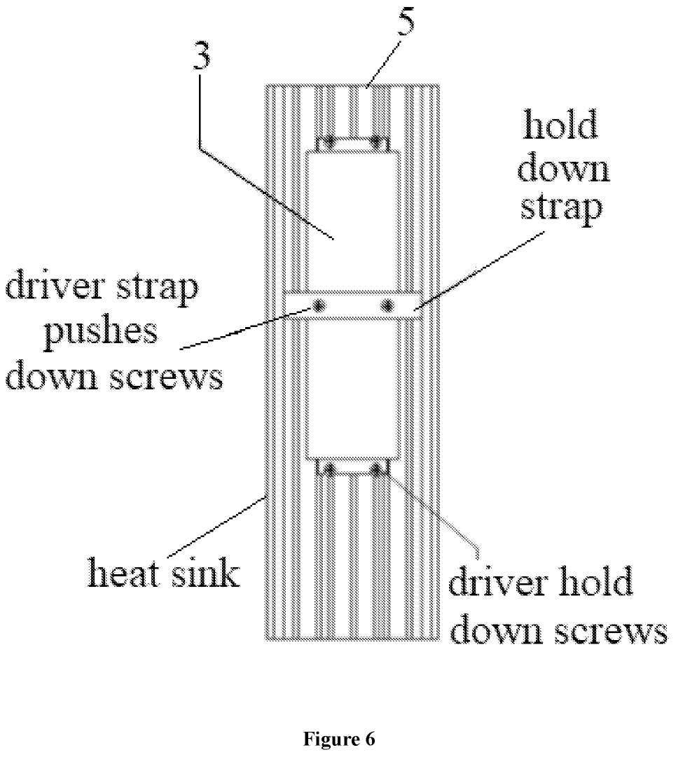

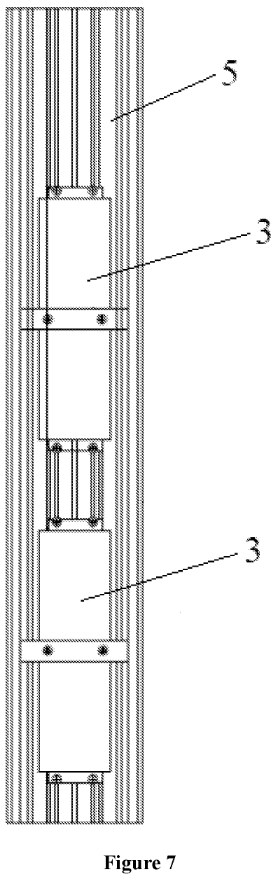

In a specific but exemplary embodiment, a “Remote Driver Hold Down Assembly 16 Inch-Model” as shown in FIG. 5 and FIG. 6 is designed. A light source driver 3 is encased or housed within a dedicated or independent driver housing 5. The driver 3 may produce a lot of heat and directly affect the life of the product. The more cooling we can provide to the driver 3, the longer the driver 3 will live. Aluminum extrusions of the housing 5 are used to dissipate or pull the heat from the driver 3. In prior art, a problem is that the driver only has mounting brackets on the ends. With reference to FIG. 5, a bracket is incorporated into the housing that holds the driver 3, to push the driver 3 up against the housing wall in the middle and to force the heat to transfer through conductive means into the aluminum extrusion of the housing 5. In a “Remote Double Driver Hold Down Assembly 30 Inch-Model” as shown in FIG. 7, two or more light source driver 3 may be encased or housed within a single driver housing 5.

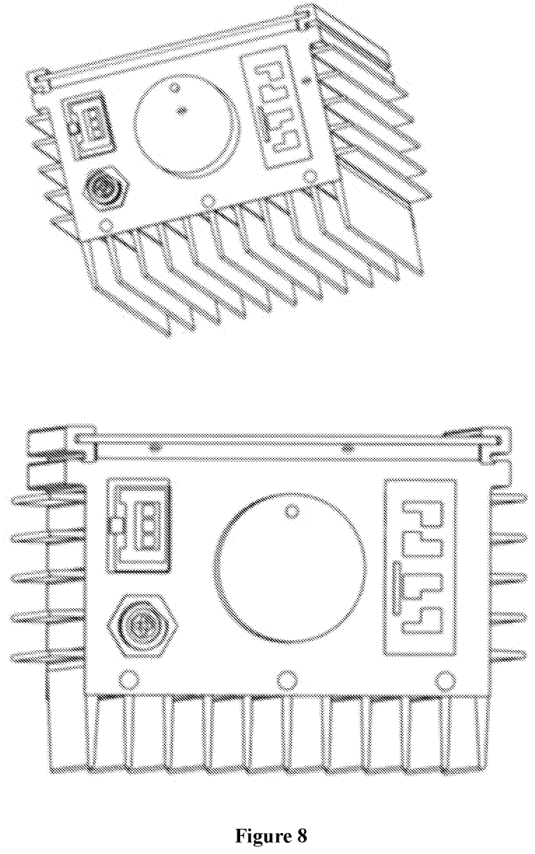

In another specific but exemplary embodiment as shown in FIG. 8, aluminum extrusions on three sides of LED driver housing 5 have enhanced cooling effect to radiate the heat out of the driver 3 into the air. The housing 5 may not only provide cooling ability but it may also be a means to make electrical connections.

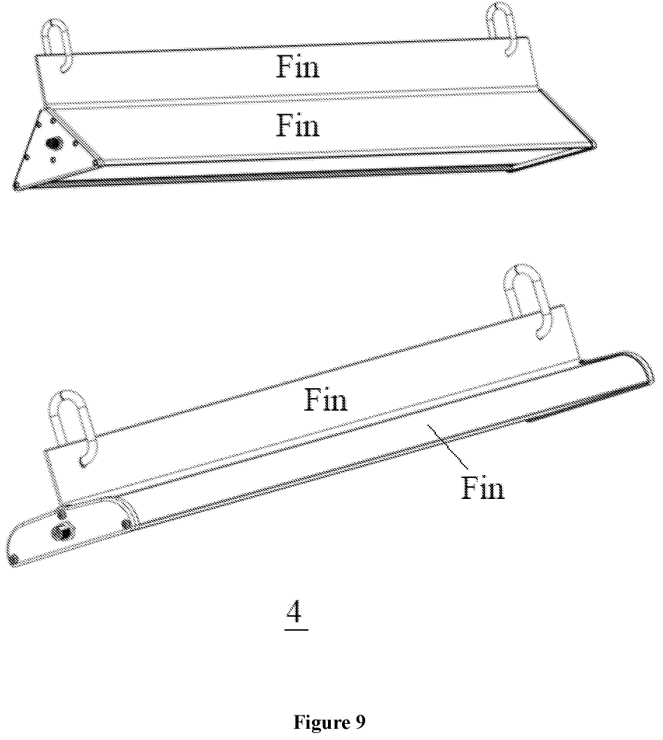

In still another specific but exemplary embodiment as shown in FIG. 9, Citadel and NCO light fixtures are two designs of light source unit 4 driven by the light source driver 3. There are fins for cooling, hanging, and shedding containments that prevent it from cooling. The LED light housing has a central fin made of aluminum that pulls heat from the LEDs that are operating through the aluminum into the vertical fin providing superior cooling capabilities. That same fin has holes in it to hang the light fixture from the building structure. The fin is also vertical preventing dust and dirt from resting on the fixture. Even if dust and dirt insulate the aluminum housing preventing the LEDs from cooling, then the vertical fin will always be free of dust and maintain cooling.

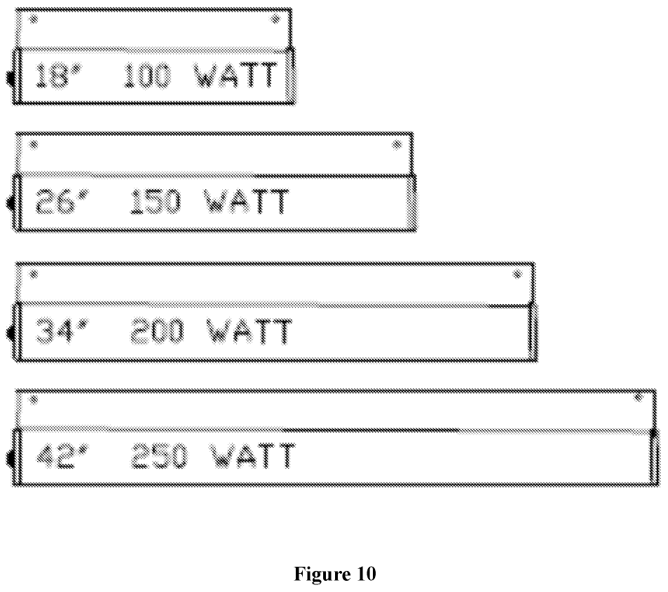

In still another specific but exemplary embodiment as shown in FIG. 10, expandable light fixtures are designed for using in light source unit 4 driven by the light source driver 3. There are many options and variables with the LED fixtures. The variables may include wattage, voltage, kelvin temperature, optics, and lenses; and nobody ever has the right inventory to meet the needs of the client. With a universal platform design of “expandable light fixture” as shown in FIG. 10, one can build the fixture after the order comes in and have fast lead times. Depending on the wattage of the fixture, one can cut the fixture to the needed length. For example, each LED board may be 50 watts, and each LED board may be 8″ long. If a supplier receives an order for a 100-watt LED fixture, then the supplier can cut the aluminum extrusion 8″ +8″+2″ for connections. If the supplier gets an order for a 150-watt LED fixture, the supplier can cut the aluminum extrusion 8″+8″+8″+2″ and then mount the correct LED boards with the correct Kelvin temperature. The supplier can quickly provide Citadel/NCO fixtures of 18-146 inch long and 100-900 watts power.

The parameters such as voltage of the fixture may be specified in the LED driver housing 5. Exemplary residential LEDs may be provided with a warm 3000 kelvin color, while an exemplary commercial light may include an exemplary 4000 kelvin cool white color. The color temperatures of the daylight color, the daylight white color, the white color, the warm white color and the incandescent color may be, for example, 6500 K (Kelvin), 5000 K, 4200 K, 3500 K, and 2900 K, respectively. Exemplary lighting fixtures may include a color rating index (CRI) of about 780, a measure of how well the lighting fixture will maintain its color over the life of the lighting device, approximately 86-88, and potentially 90 or greater.

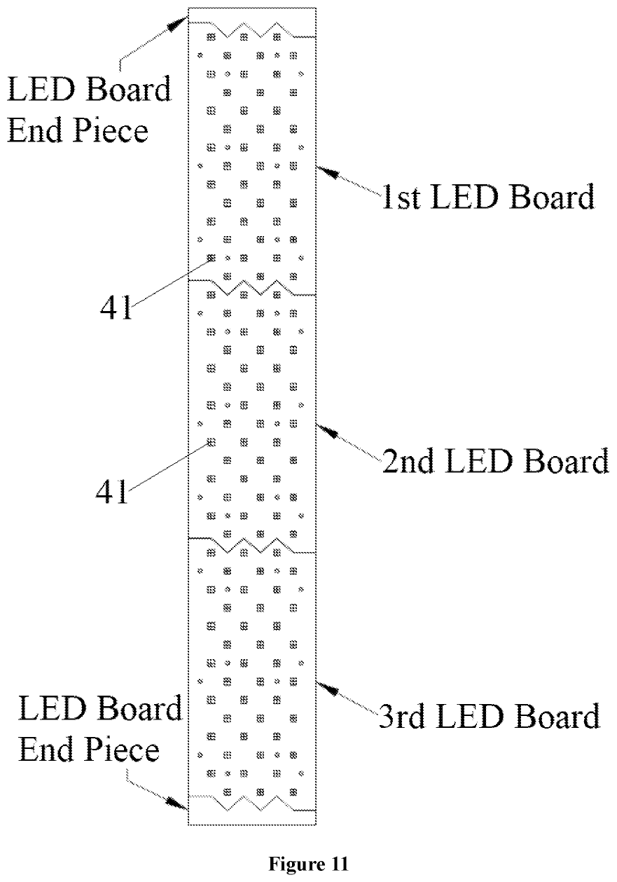

In still another specific but exemplary embodiment as shown in FIG. 11, LED boards are designed so there are no dark spots. LED boards are designed with two or more zig zag (shark's teeth) boundaries/edges so that, when one puts multiple LED boards together in a row, there will not be a dark spot (at where they meet). If the LED board edge is flat, then there would be a dark spot.

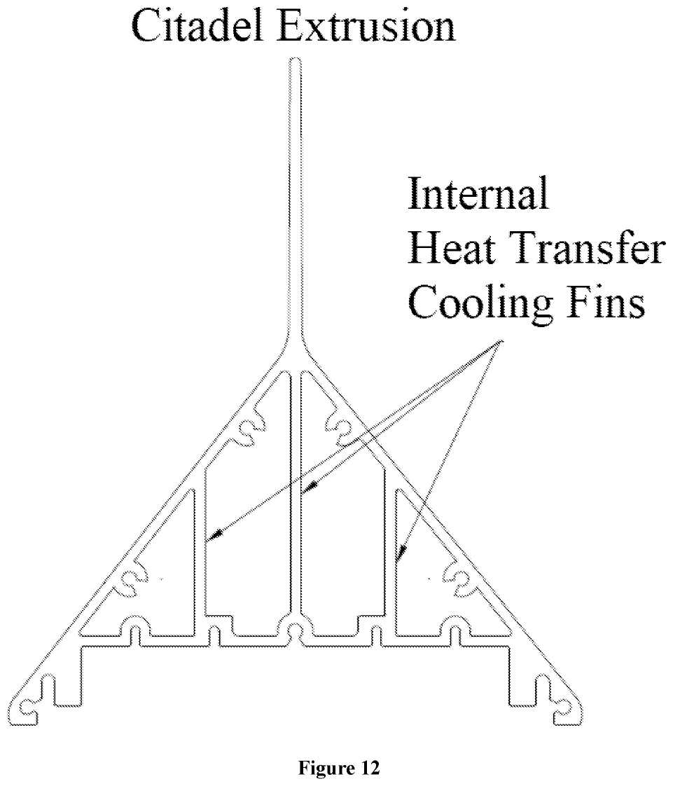

In still another specific but exemplary embodiment as shown in FIG. 12, internal cooling fins are designed and used in LED fixtures. LED fixtures need cooling fins to cool the LED boards. In prior art, people put them on the outside of the fixture. In this embodiment of the invention, the inventors have arranged the cooling fins inside, so they don't fill up with dust and dirt which lowers the cooling effectiveness.

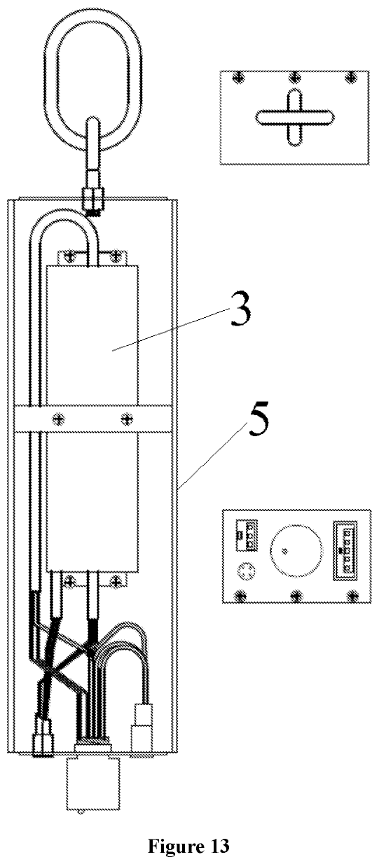

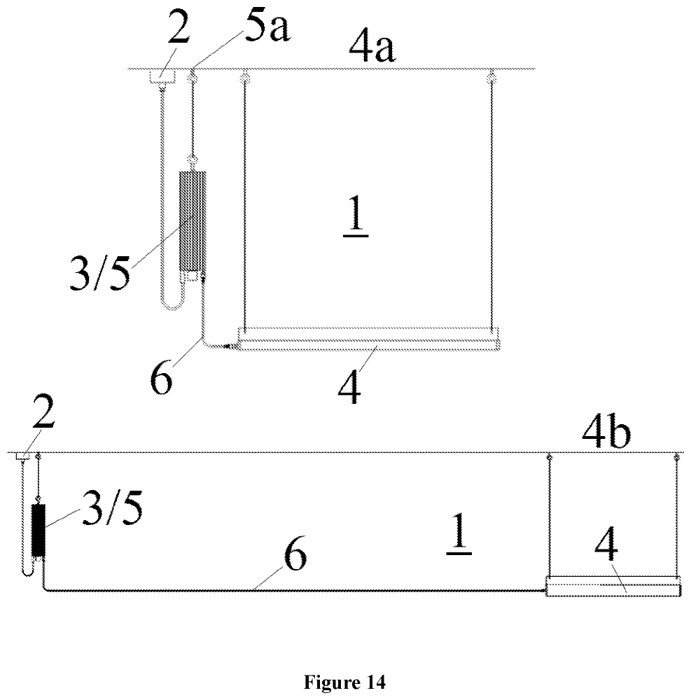

FIG. 13 illustrates the wiring assembly of an exemplary remote light source driver 3 within its housing 5. In the prior art, the LED driver is the weakest link, and everyone has the driver mounted in the fixture. If the LED driver fails, one has to either throw the fixture away, or pull it apart and repair it. In a specific but exemplary embodiment as shown in FIG. 14, LED driver housing 5 is remotely connected. The driver 3 cannot handle much heat, so by having it remote one can mount the LED light in an area with lots of heat but mount the driver in a cooler part of the building. This same driver housing would be used for any suitable fixtures, such as (but not limited to) NCO, Citadel, Turret and others. Additional benefits include speed shipping, the supplier can have these made up ahead of time and it doesn't matter what kind of LED fixture is ordered or light output color. Second, no need to regrid the electrical if one wants to move the fixtures around. National Electrical Code requires that building voltage to be within the footprint of the LED fixture, which the invented remote driver assembly will be—but with the power going to the LED light engine is low voltage and does not need to be within the footprint of the building electrical. In the prior art, if one wants to move a fixture, he/she has to relocate the building electrical where the fixtures' new location will be. With the invented design, one can mount the driver 3 in the original location and then move the fixture anywhere he/she wants to. As shown in FIG. 14, a method of the invention includes the following steps: (i) providing a lighting system 1 as described above and as illustrated in FIGS. 1 and 2; (ii) mounting the light source driver 3 in a first location 5a in a building; (iii) mounting the light source unit 4 in a second location 4a in the building; (iv) moving the light source unit 4 to, and mounting it in, a third location 4b in the building without moving the light source driver 3 away from the first location 5a and without re-griding the utility electrical system in the building. An advantage of the invention is that, when the light source driver 3 fails, the user can keep (not throw away) the light source unit 4 or maintaining the integrity of the light source unit 4 without pulling it apart and repairing it. By the same token, when the light source unit 4 fails, the user can keep (not throw away) the light source driver 3 or maintaining the integrity of the light source driver 3 without pulling it apart and repairing it. In preferred embodiments, the first location 5a has a temperature lower than the second location 4a or the third location 4b.

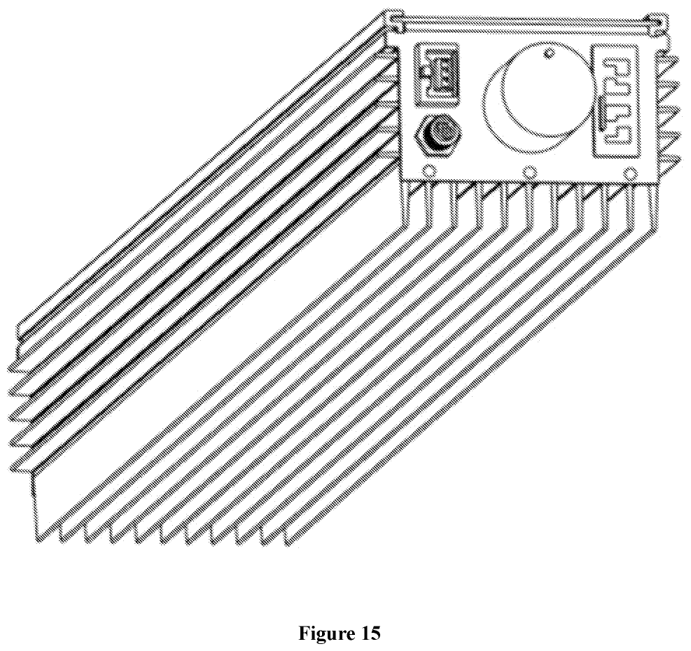

Inventors Tim Wasmer, Dave Wasmer and Jun Wang have also invented a new, original, and ornamental design for a LED Driver Housing, and claim the ornamental design for a LED Driver Housing, as shown and described in the following and in FIGS. 15-27.

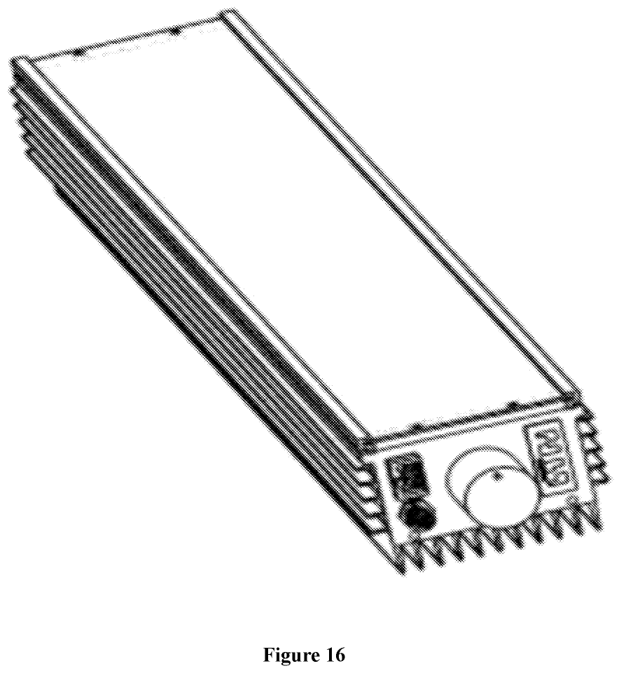

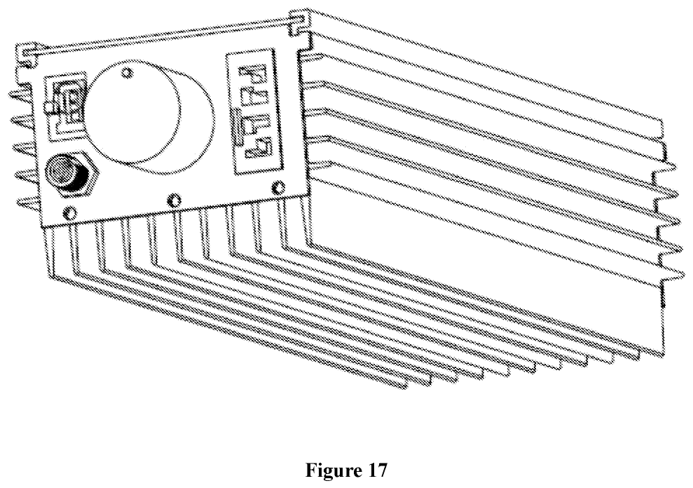

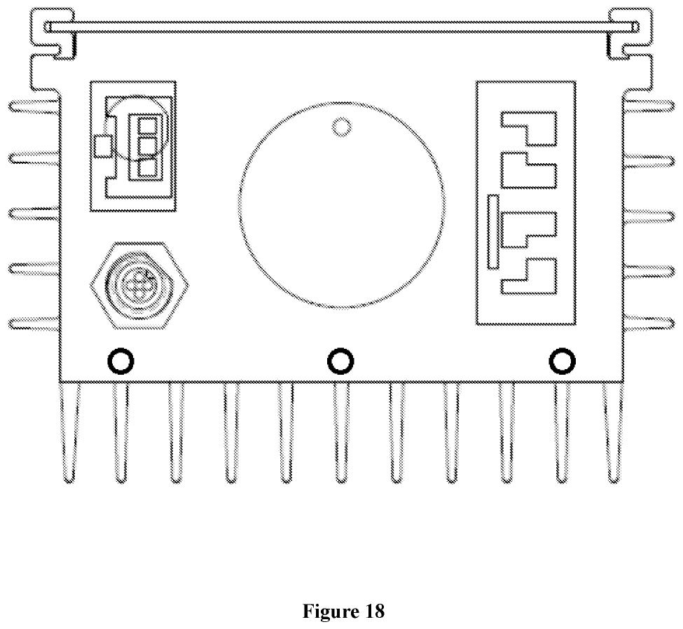

FIG. 15 is a front/right/bottom perspective view of a first embodiment of a LED Driver Housing; FIG. 16 is a front/right/top perspective view thereof; FIG. 17 is a rear/right/bottom perspective view thereof; and FIG. 18 is a right-side elevational view thereof.

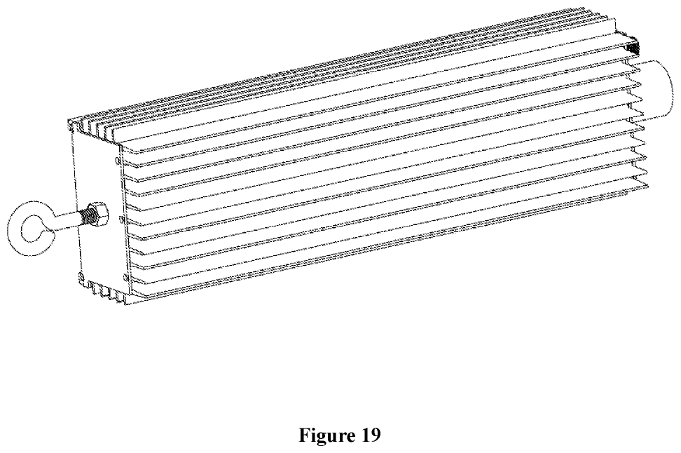

FIG. 19 is a front/left/bottom perspective view of a second embodiment of a LED Driver Housing.

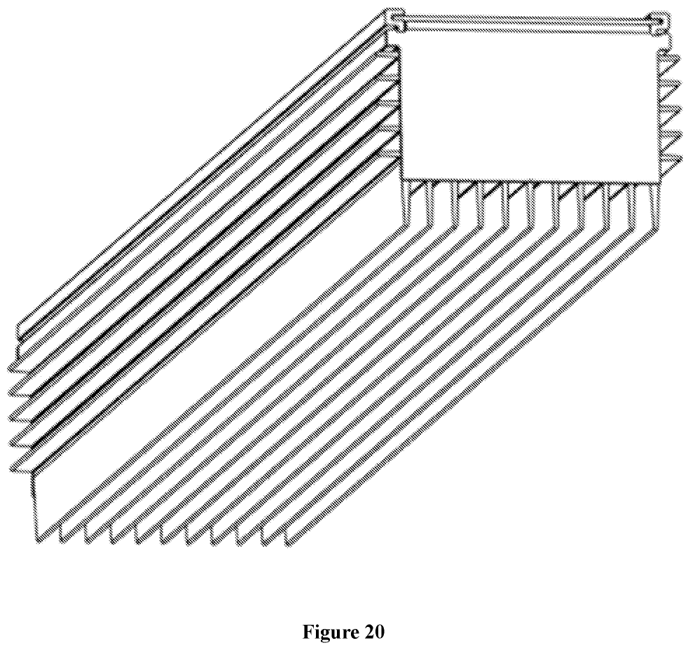

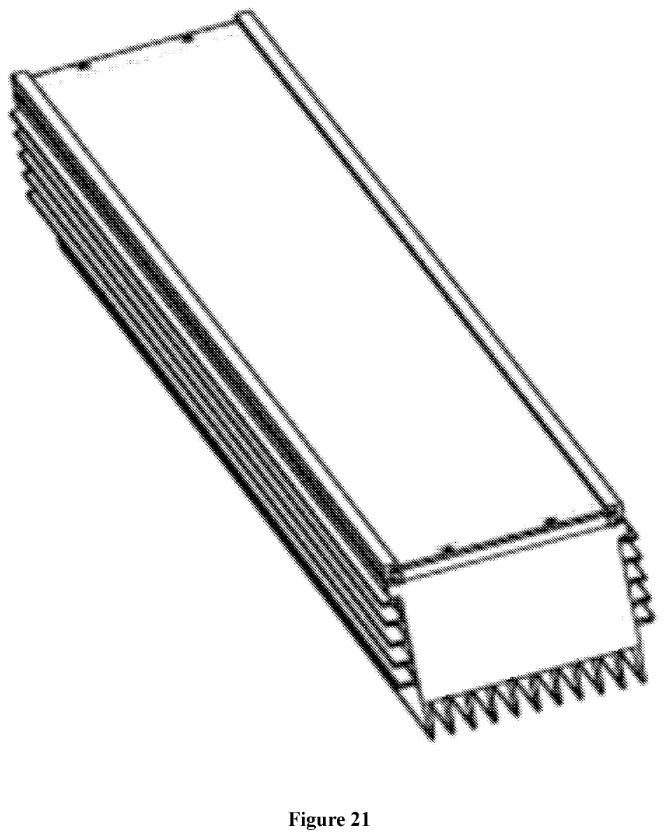

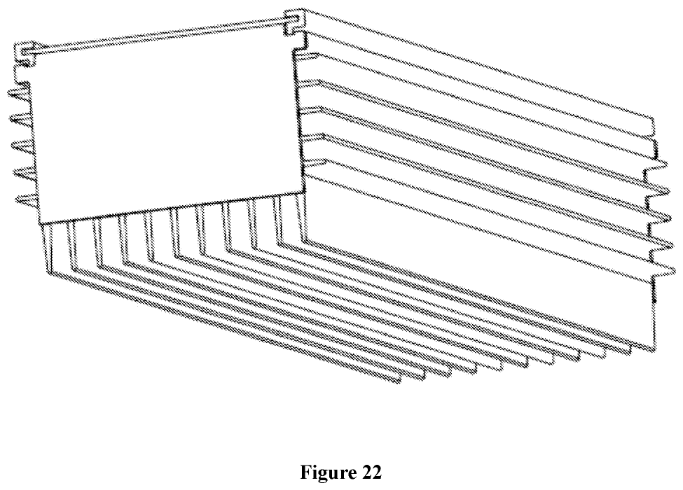

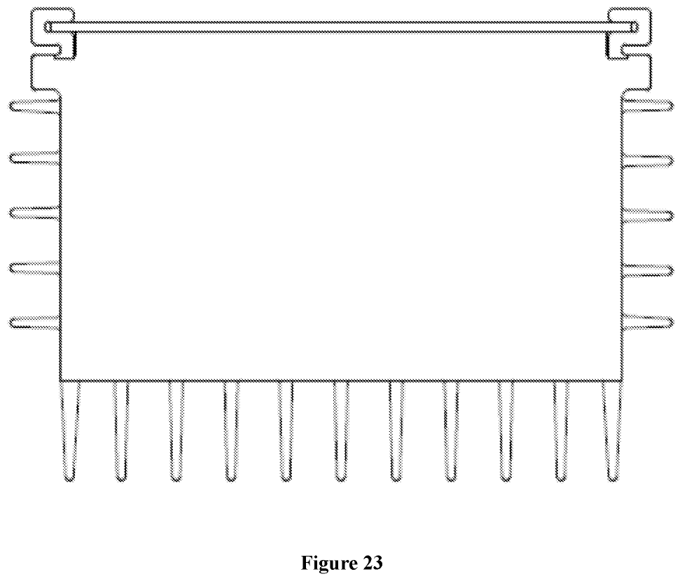

FIG. 20 is a front/right/bottom perspective view of a third embodiment of a LED Driver Housing; FIG. 21 is a front/right/top perspective view thereof; FIG. 22 is a rear/right/bottom perspective view thereof; and FIG. 23 is a right-side elevational view thereof.

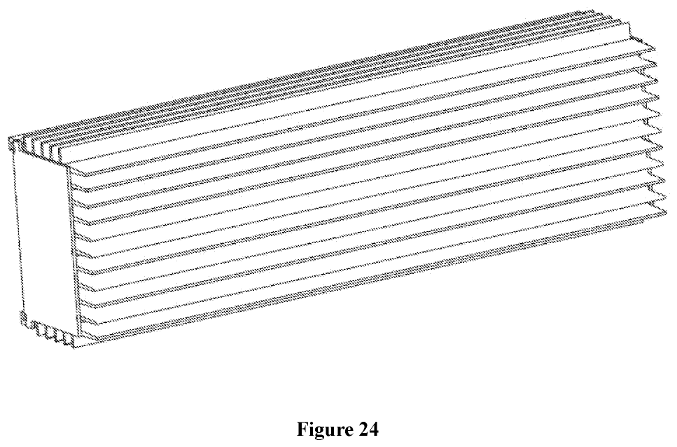

FIG. 24 is a front/left/bottom perspective view of a fourth embodiment of a LED Driver Housing.

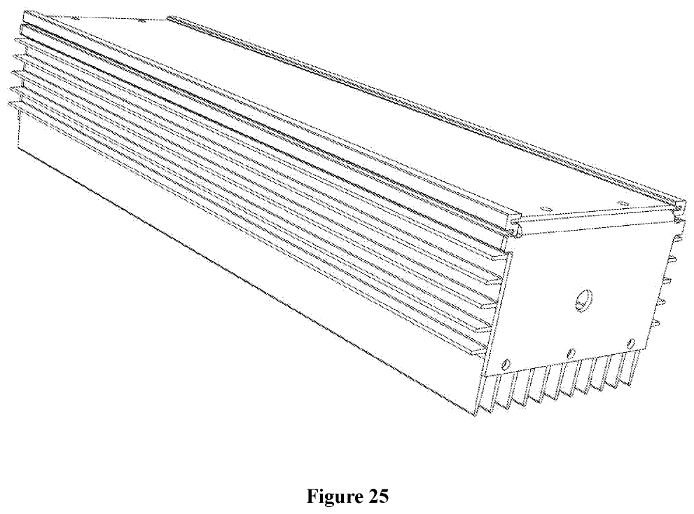

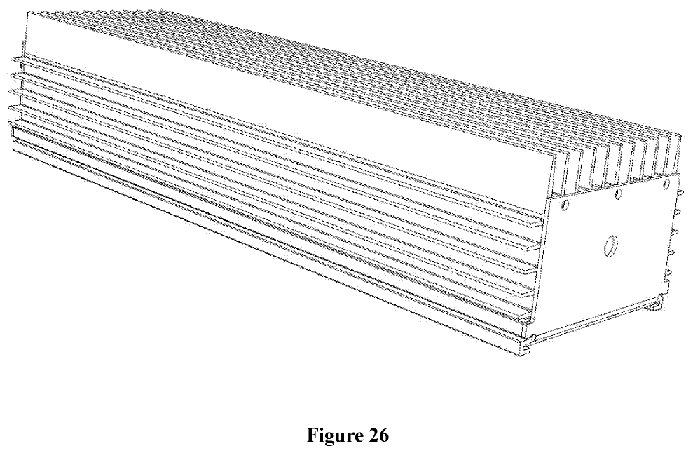

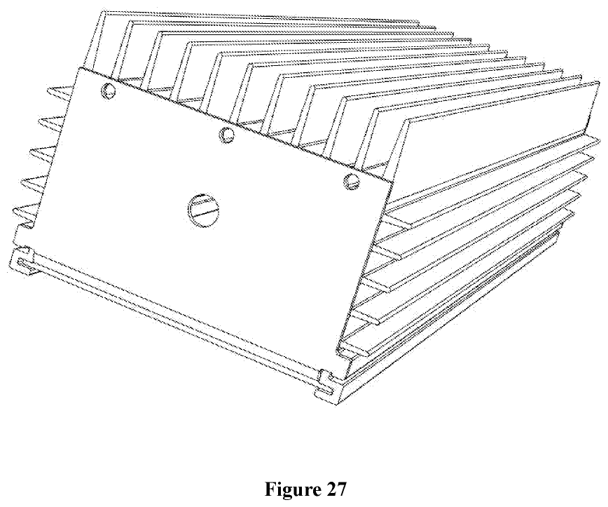

FIG. 25 is a rear/left/top perspective view of a fifth embodiment of a LED Driver Housing; FIG. 26 is a front/left/bottom perspective view thereof; and FIG. 27 is rear/left/bottom perspective view thereof.

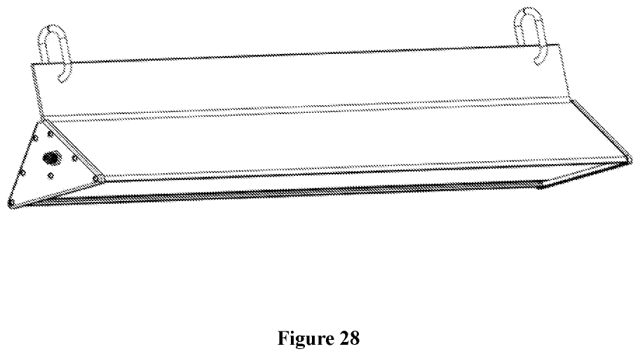

Inventors Tim Wasmer, Dave Wasmer and Jun Wang have also invented a new, original, and ornamental design for a Lighting Fixture such as a LED Lighting Fixture, and claim the ornamental design for a Lighting Fixture such as a LED Lighting Fixture, as shown and described in the following and in FIGS. 28-48.

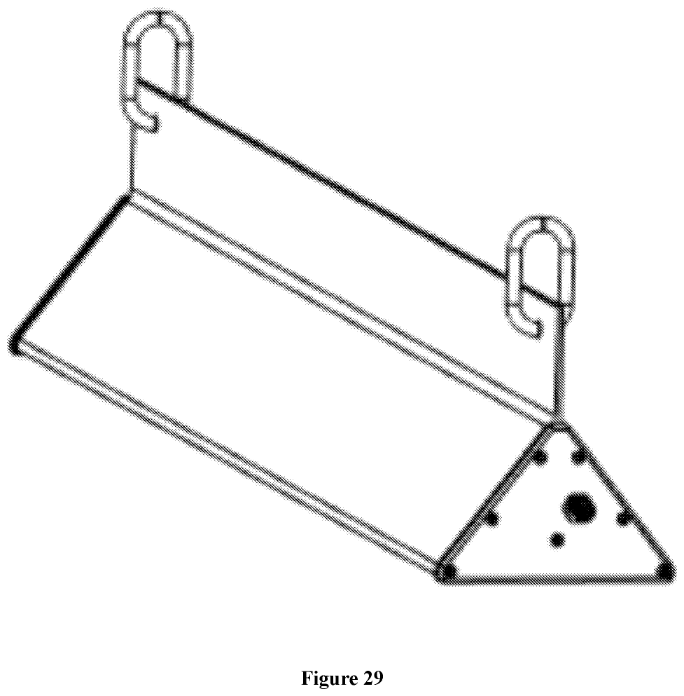

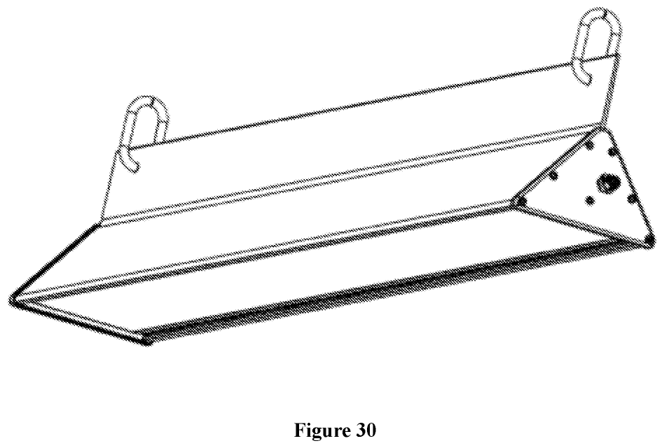

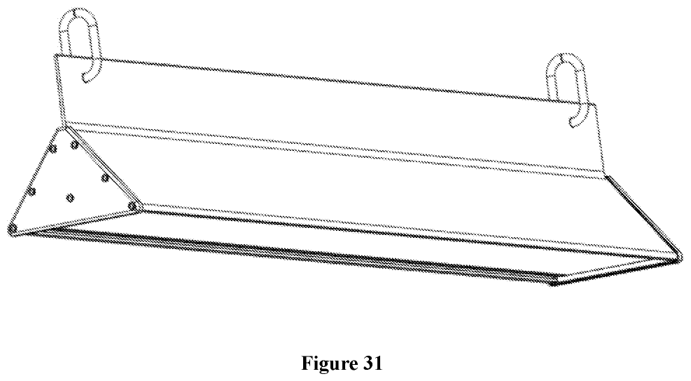

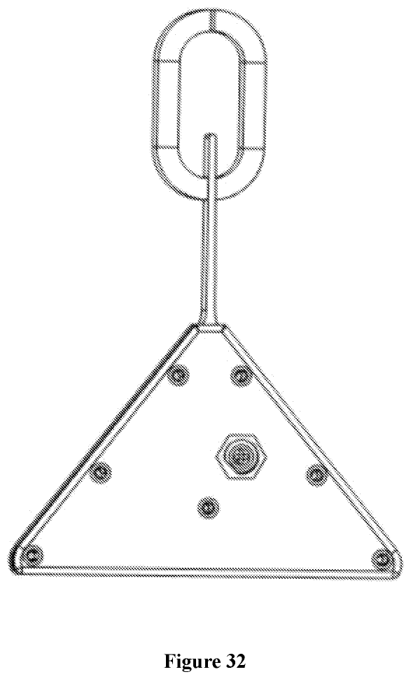

FIG. 28 is a front/left/bottom perspective view of a first embodiment of a Lighting Fixture (Citadel); FIG. 29 is a rear/left/top perspective view thereof; FIG. 30 is a rear/left/bottom perspective view thereof; FIG. 31 is a rear/right/bottom perspective view thereof; and FIG. 32 is a left side elevational view thereof.

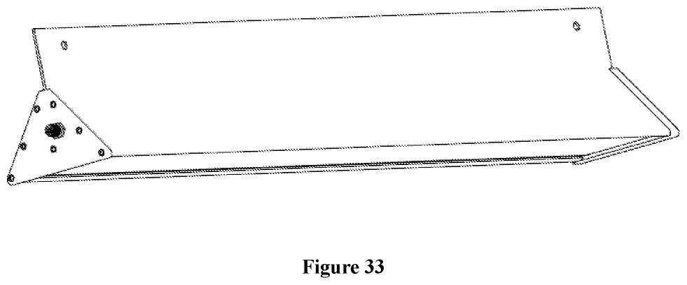

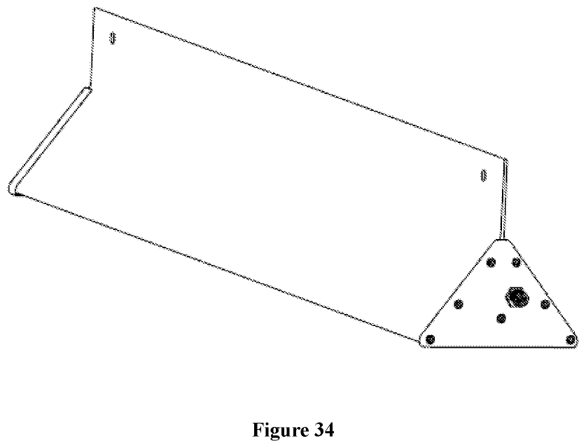

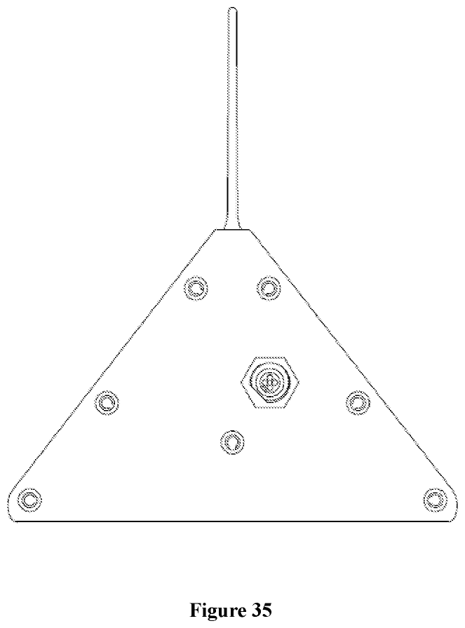

FIG. 33 is a front/left/bottom perspective view of a second embodiment of a Lighting Fixture (Citadel); FIG. 34 is a rear/left/top perspective view thereof; and FIG. 35 is a left side elevational view thereof.

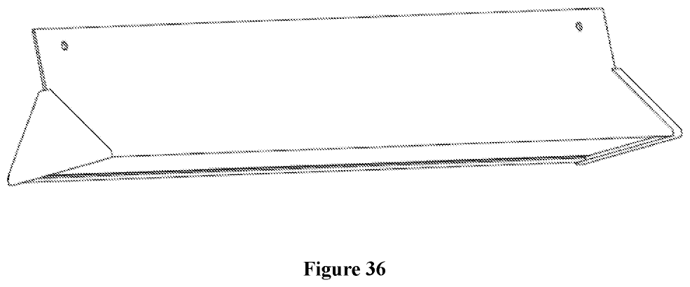

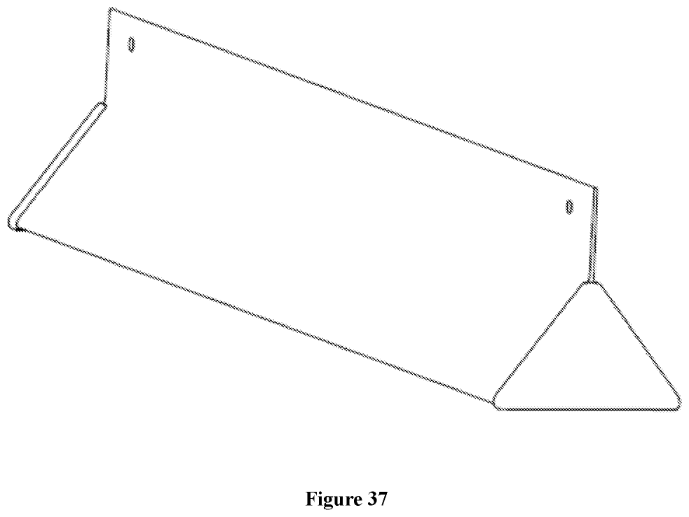

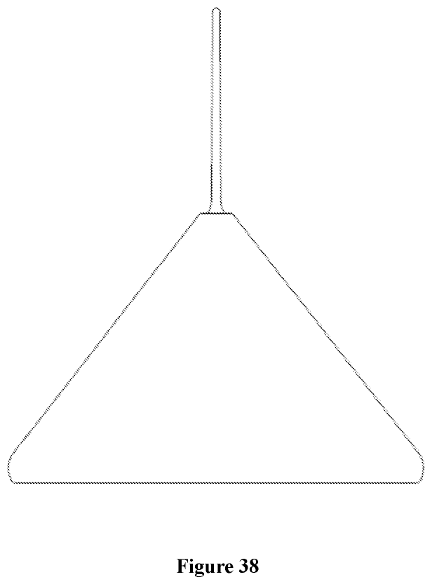

FIG. 36 is a front/left/bottom perspective view of a third embodiment of a Lighting Fixture (Citadel); FIG. 37 is a rear/left/top perspective view thereof; and FIG. 38 is a left side elevational view thereof.

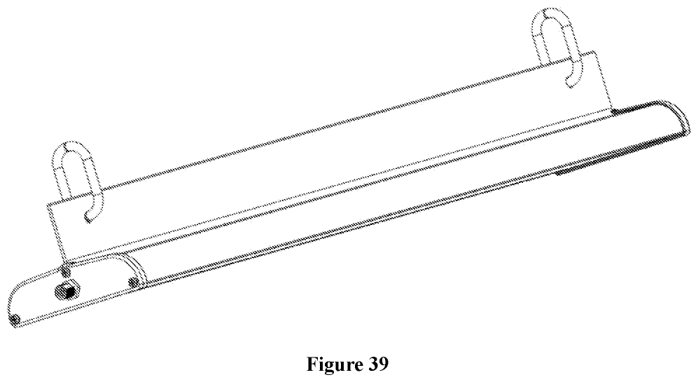

FIG. 39 is a front/left/bottom perspective view of a fourth embodiment of a Lighting Fixture (NCO).

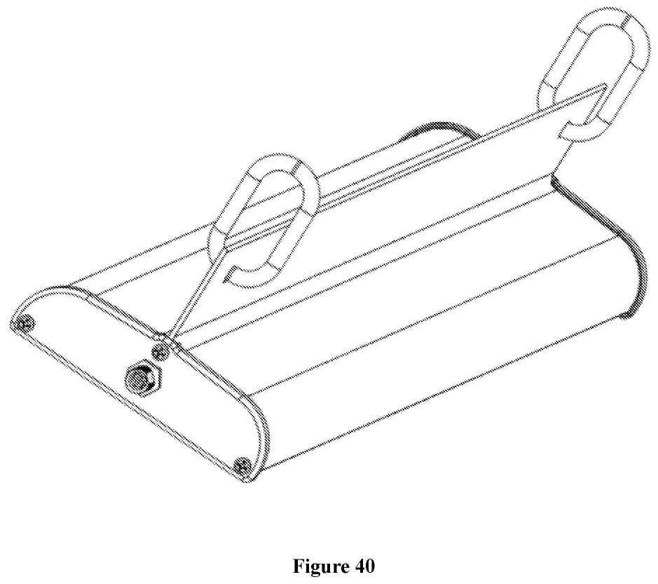

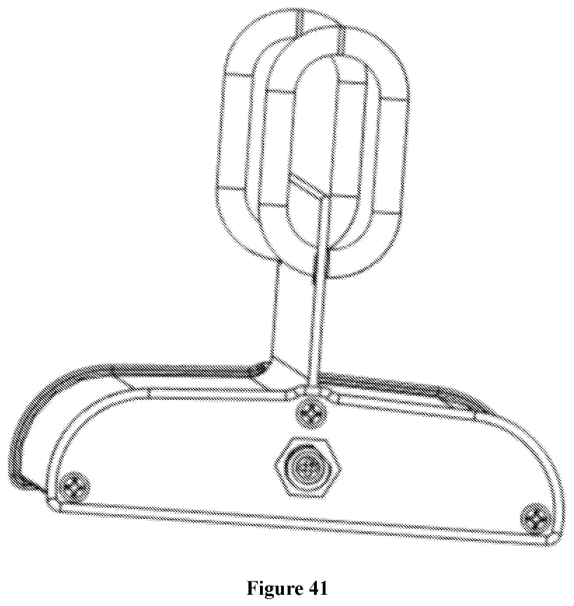

FIG. 40 is a front/left/top perspective view of a fifth embodiment of a Lighting Fixture (NCO); and FIG. 41 is a rear/left/top perspective view thereof.

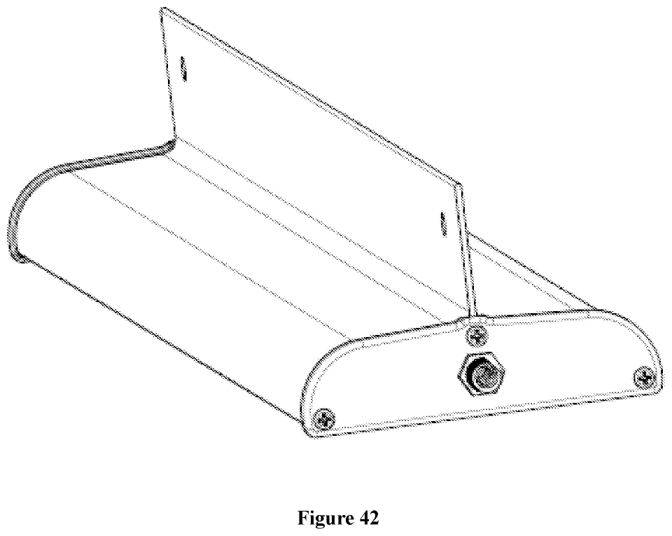

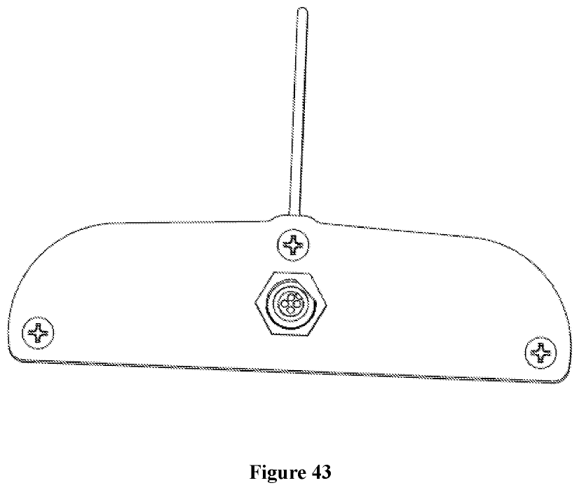

FIG. 42 is a rear/left/top perspective view of a sixth embodiment of a Lighting Fixture (NCO); and FIG. 43 is a left side elevational view thereof.

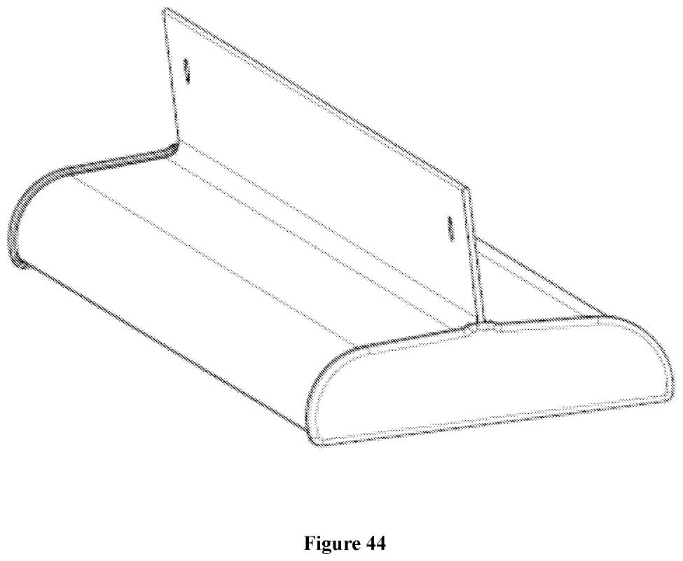

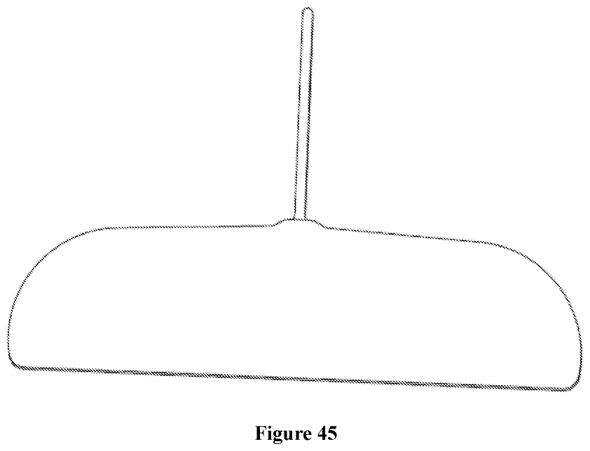

FIG. 44 is a rear/left/top perspective view of a seventh embodiment of a Lighting Fixture (NCO); and FIG. 45 is a left side elevational view thereof.

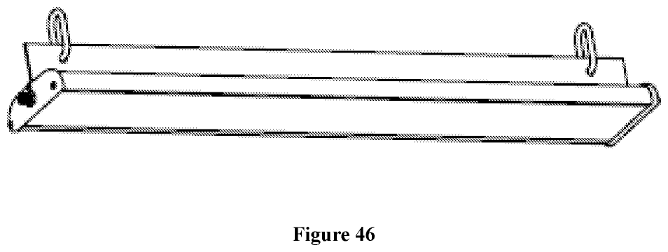

FIG. 46 is a front/left/bottom perspective view of an eighth embodiment of a Lighting Fixture (NCO).

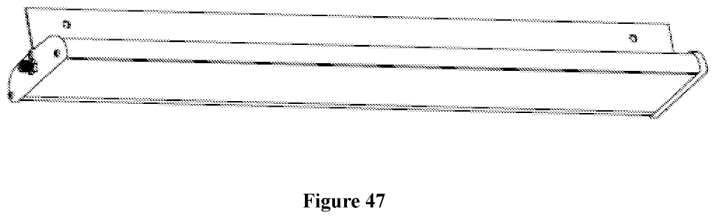

FIG. 47 is a front/left/bottom perspective view of a ninth embodiment of a Lighting Fixture (NCO).

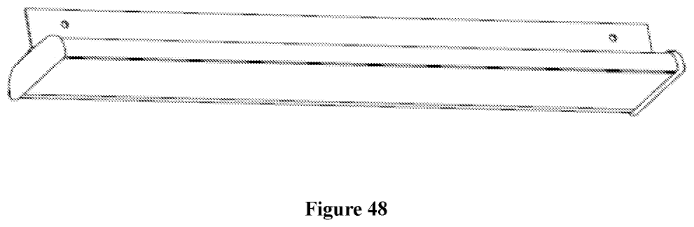

FIG. 48 is a front/left/bottom perspective view of a tenth embodiment of a Lighting Fixture (NCO).

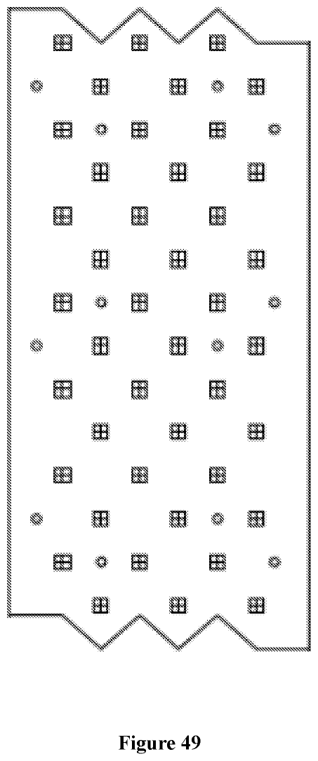

Inventors Tim Wasmer, Dave Wasmer and Jun Wang have also invented a new, original, and ornamental design for a LED Board used in any LED lighting Fixture, and claim the ornamental design for a LED Board used in any LED lighting Fixture, as shown and described in the following and in FIGS. 49-54.

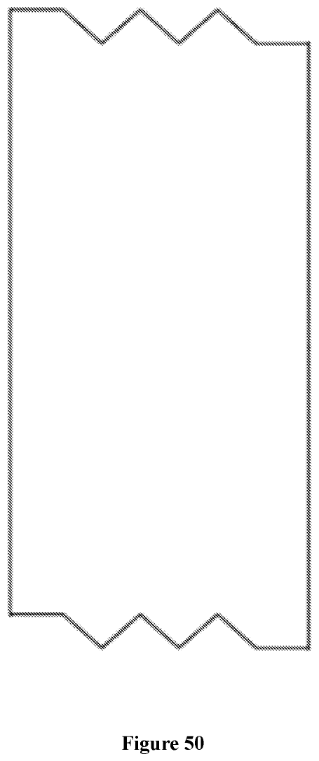

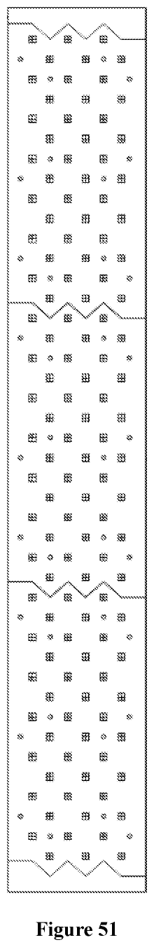

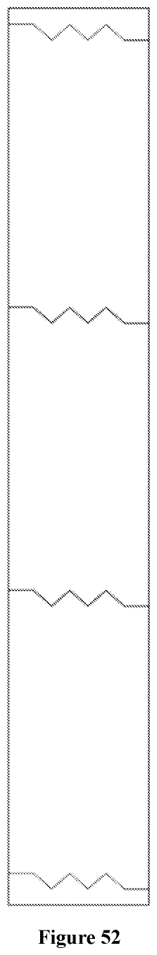

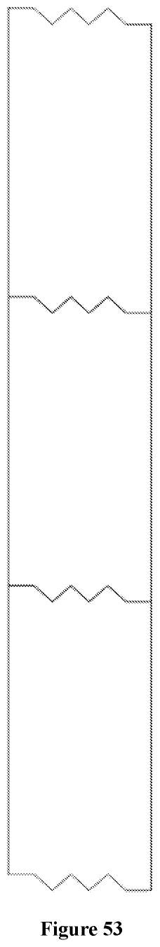

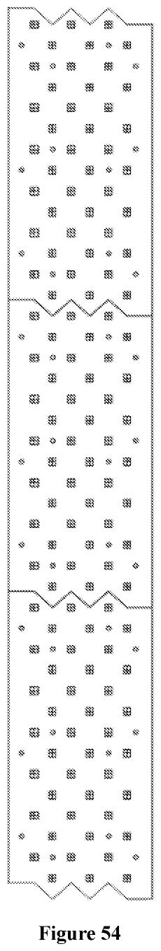

FIG. 49 is a bottom plan view of a first embodiment of a LED Board; FIG. 50 is a bottom plan view of a second embodiment of a LED Board; FIG. 51 is a bottom plan view of a third embodiment of a LED Board; FIG. 52 is a bottom plan view of a fourth embodiment of a LED Board; FIG. 53 is a bottom plan view of a fifth embodiment of a LED Board; and FIG. 54 is a bottom plan view of a sixth embodiment of a LED Board.

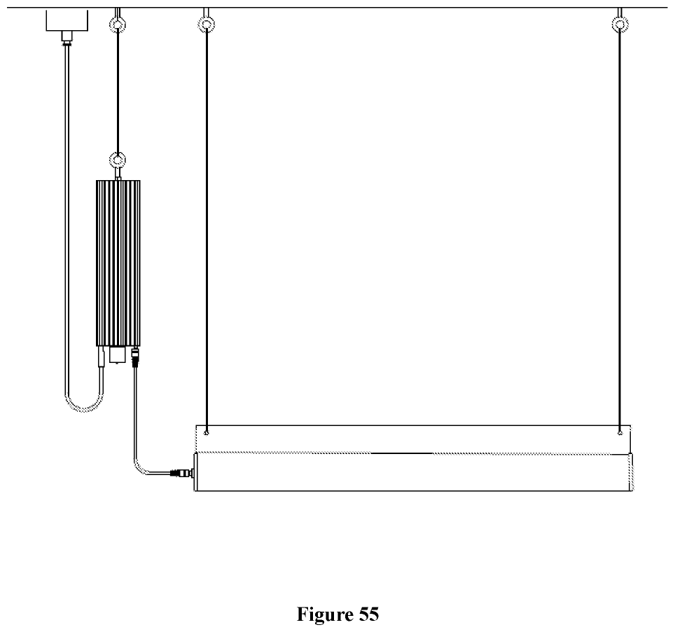

Inventors Tim Wasmer, Dave Wasmer and Jun Wang have also invented a new, original, and ornamental design for a LED Lighting System (or Product, or Assembly), and claim the ornamental design for a LED Lighting System (or Product, or Assembly), as shown and described in the following and in FIGS. 55-58.

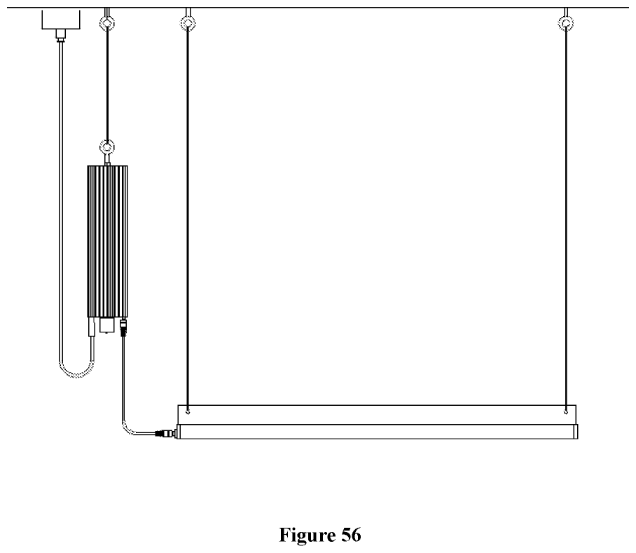

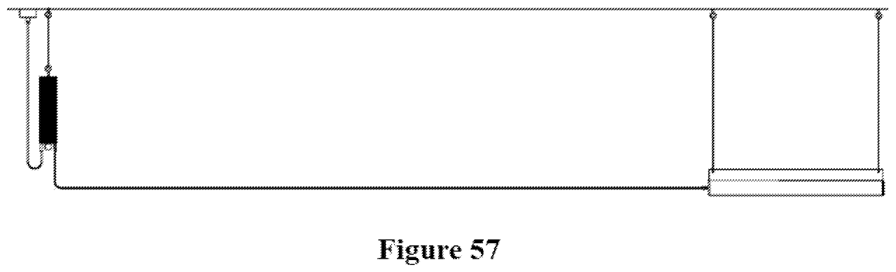

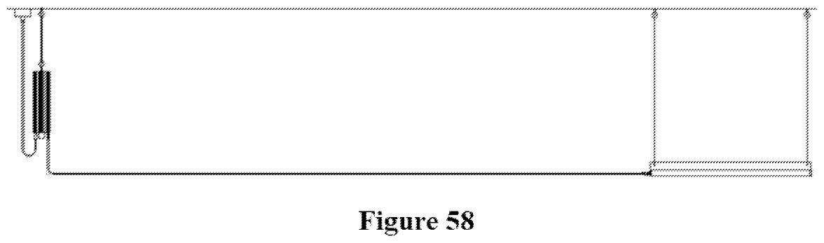

FIG. 55 is a front elevational view of a first embodiment of the LED Lighting System (or Product, or Assembly); FIG. 56 is a front elevational view of a second embodiment of the LED Lighting System (or Product, or Assembly); FIG. 57 is a front elevational view of a third embodiment of the LED Lighting System (or Product, or Assembly); and FIG. 58 is a front elevational view of a fourth embodiment of the LED Lighting System (or Product, or Assembly).

In the foregoing specification, embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicant to be the scope of the invention, is the literal and equivalent scope of the set of claims that issue from this application, in the specific form in which such claims issue, including any subsequent correction.

1. A lighting system comprising:
a main power source,
a light source driver electrically coupled to the main power source, and
a light source unit driven by the light source driver;
wherein the light source driver is encased within a dedicated or independent driver housing,
wherein the light source driver and the driver housing are physically and electrically connected to the light source unit via a flexible cord, and
wherein the length of the flexible cord is so configured that the light source unit can be installed at different locations inside a building without moving the light source driver around.

2. The lighting system according to claim 1, wherein the light source unit is not encased within or mounted to said driver housing, wherein the light source driver is not mounted in, on or with the light source unit, and wherein the light source driver is not mechanically fixed (or it is movable) to the light source unit when the light source unit is in a working condition such as illuminating light.

3. The lighting system according to claim 1, wherein the main power source is a power grid, a public utility electrical grid, or a DC power source.

4. The lighting system according to claim 1, wherein the light source unit is a solid-state lighting (SSL) fixture that comprises a semiconductor light-emitting diode (LED), organic light-emitting diodes (OLED), polymer light-emitting diodes (PLED), or any combination thereof, e.g. a (retrofit) lamp.

5. The system according to claim 1, wherein the light source driver is an isolated power driver, such as a LED driver with a LED circuit to power a light-emitting diode (LED) in the light source unit.

6. The lighting system according to claim 1, wherein the light source unit comprises one or more light-emitting diodes (LEDs) of a LED circuit, and all other (non-LED) components of the LED circuit are included in the light source driver within the driver housing.

7. The lighting system according to claim 6, wherein said all other (non-LED) components of the LED circuit controls or regulates the current level of a LED current through the LED and thus the light output of the LED within said light source unit.

8. The lighting system according to claim 6, wherein said all other (non-LED) components of the LED circuit are selected from a current-limiting resistor such as a series resistor, an active constant current regulator, a depletion-mode MOSFET (metal-oxide-semiconductor field-effect transistor), a low drop-out (LDO) constant current regulator, a switched-mode power supply, a power MOSFET, a power integrated circuit (IC) chip, a power switch, an electromagnetic relay including a coil, a rectifier, a pulse-width modulator, an AC/DC converter or inverter configured to transform alternating current (AC) power to direct current (DC) power, and the like, and any combination thereof.

9. The lighting system according to claim 1, wherein the light source unit comprises a string or an array of multiple LEDs that are connected in series.

10. The lighting system according to claim 9, wherein the multiple LEDs are mounted on a LED board having two boundaries/edges with a zig zag (shark's teeth) profile.

11. A method of illuminating the internal space of a building, comprising
(i) providing a lighting system according to claim 1;
(ii) mounting the light source driver in a first location in the building;
(iii) mounting the light source unit in a second location in the building; and
(iv) moving the light source unit to, and mounting it in, a third location in the building without moving the light source driver away from the first location and without re-griding the utility electrical system in the building.

12. The method according to claim 11, further comprising:
when the light source driver fails, keeping (not throwing away) the light source unit or maintaining the integrity of the light source unit without pulling it apart and repairing it.

13. The method according to claim 11, wherein the first location has a temperature lower than the second location or the third location.

14. The method according to claim 11, wherein Step (i) includes (i-a) manufacturing the light source driver and its driver housing before manufacturing the light source unit, (i-b) shipping the light source driver and its driver housing to the building as needed, and (i-c) manufacturing one or more light source units and shipping the units to the building as needed after step (i-b).

15. The method according to claim 11, wherein the building is selected from residential buildings, commercial buildings, retail buildings, shopping centers, motels, hotels, casinos, resorts, self-storages, warehouses, car washes, theaters, office buildings, laboratories, data centers, call centers, showrooms, industrial buildings, agricultural buildings, barns, chicken coops or chicken houses, cow-sheds, farmhouses, greenhouse, institutional buildings, arenas, libraries, museums, observatories, community halls, churches, cathedrals, temples, city halls, courthouses, police stations, post offices, airport terminal, bus station, subway stations, railroad stations, film studios, gyms, and the like.

16. The method according to claim 11, wherein the light source unit driven is not encased within or mounted to said driver housing, wherein the light source driver is not mounted in, on or with the light source unit, and wherein the light source driver is not mechanically fixed (or it is movable) to the light source unit when the light source unit is in a working condition such as illuminating light.

17. The method according to claim 11, wherein the light source unit comprises one or more light-emitting diodes (LEDs) of a LED circuit, and all other (non-LED) components of the LED circuit are included in the light source driver within the driver housing.

18. The method according to claim 17, wherein said all other (non-LED) components of the LED circuit controls or regulates the current level of a LED current through the LED and thus the light output of the LED within said light source unit.

19. The method according to claim 17, wherein said all other (non-LED) components of the LED circuit are selected from a current-limiting resistor such as a series resistor, an active constant current regulator, a depletion-mode MOSFET (metal-oxide-semiconductor field-effect transistor), a low drop-out (LDO) constant current regulator, a switched-mode power supply, a power MOSFET, a power integrated circuit (IC) chip, a power switch, an electromagnetic relay including a coil, a rectifier, a pulse-width modulator, an AC/DC converter or inverter configured to transform alternating current (AC) power to direct current (DC) power, and the like, and any combination thereof.

20. The method according to claim 11, wherein the light source unit comprises a string or an array of multiple LEDs that are connected in series.
